(19) United States
(12) Patent Application Publication
(10) Pub. No.: US 2018/0147439 A1
(43) Pub. Date: May 31, 2018

(54) Barbell Clamp

(71) Applicant: Jason Woods, Plymouth, IN (US)

(72) Inventor: Jason Woods, Plymouth, IN (US)

(21) Appl. No.: 15/827,504

(22) Filed: Nov. 30, 2017

Related U.S. Application Data
(60) Provisional application No. 62/428,085, filed on Nov. 30, 2016.

(51) Int. Cl. A63B 21/072; F16B 2/10; F16B 2/18; F16B 2/00

(52) U.S. Cl. CPC A63B 21/0728; F16B 2/10; F16B 2/185; A63B 21/075; A63B 2209/00; A63B 21/0724; F16B 2/005

(57) ABSTRACT

The combination of a barbell and a barbell clamp for use in weightlifting that comprises a plurality of levers forming an oblong hole, a biasing spring, and a fastener.

### CROSS-REFERENCE TO RELATED APPLICATIONS

This application claims the benefit of U.S. Provisional Application No. 62/428,085 filed Nov. 30, 2017, entitled “Fitness Barbell Clamp” to Jason Woods. The disclosures of which are expressly incorporated by reference herein.

### SUMMARY OF THE DISCLOSURE

The present disclosure relates to a device for securing weight lifting plates to a barbell used in the field of physical fitness and weightlifting, which enables a user to efficiently secure the plates to the barbell and maintain focus.

According to one aspect of the present disclosure, a barbell and barbell clamp assembly is provided. The barbell includes a shaft and two sleeves coupled to the shaft. The barbell clamp includes a pair of levers that are pivotally coupled together. Each lever includes a jaw that has a contact surface. The jaws cooperate to define a central hole. The barbell is positioned in the central hole. A handle is coupled to the jaw. The pair of levers are movable relative to each other to move the contact surfaces towards and away from each other.

According to another aspect of the present disclosure, a barbell and barbell clamp assembly is provided. The barbell includes a shaft and two sleeves coupled to the shaft. The barbell clamp includes a pair of levers coupled to the barbell. Each lever includes a jaw having a contact surface. The contact surfaces cooperate to define a central with the barbell being positioned in the central hole. Each lever also includes a handle coupled to the jaw. The barbell clamp also includes a means for biasing the jaws towards a closed position. The biasing means is spaced apart from the central hole.

According to another aspect of the present disclosure, and barbell and barbell clamp assembly is provided. The barbell has a shaft and two sleeves. The barbell clamp includes a pair of levers. Each lever includes a jaw that has a rubber contact surface. The rubber contact surfaces cooperate to define a central hole. The barbell is positioned in the central hole. Each lever also includes a handle coupled to the jaw.

### BRIEF DESCRIPTION OF THE DRAWINGS

The aforementioned aspects and many of the intended features of this disclosure will grow to be appreciated at a greater level once references to the following accompanying illustrations are expounded upon.

FIG. 1 is a view of an end of a barbell with a weight lifting plate and a barbell clamp securing the plate on the barbell;

FIG. 2 is a perspective view of an embodiment of the barbell clamp of FIG. 1 showing the clamp in a closed position;

FIG. 3 is an exploded view of the barbell clamp assembly of FIG. 1 showing a spring, a pair of levers, and a fastener that connects the levers;

FIG. 4 is a side view of an embodiment of the spring of FIG. 3; and

FIG. 5 is a side view of an embodiment of a barbell clamp lever showing a gripping surface defined by a rubber insert.

Equivalent reference components point to corresponding parts throughout the several views. Unless otherwise indicated, the components shown in the drawings are proportional to each other. Wherein, the illustrations depicted are manifestations of the disclosure, and such illustrations shall not be interpreted as limiting the scope of the disclosure.

For the purposes of promoting an understanding of the principals of the disclosure, reference will now be made to the embodiments illustrated in the drawings, which are described below. The embodiments disclosed below are not intended to be exhaustive or limit the disclosure to the precise form disclosed in the following detailed description. Rather, the embodiments are chosen and described so that others skilled in the art may utilize their teachings. It will be understood that no limitation of the scope of the disclosure is thereby intended. The disclosure includes any alterations and further modifications in the illustrative devices and described methods and further applications of the principles of the disclosure which would normally occur to one skilled in the art to which the disclosure relates.

### DETAILED DESCRIPTION OF THE DRAWINGS

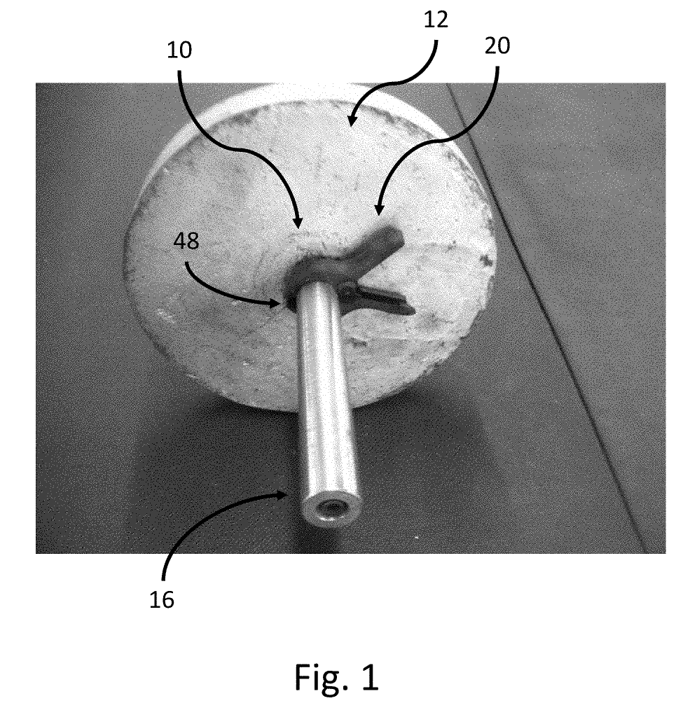

Referring to FIG. 1, a barbell 10 is shown in combination with a weight lifting plate 12 secured to barbell 10 with a barbell clamp 20. Barbell 10 has center bar (not shown) and a pair of sleeves 16 (one shown) having circular cross-sections. Weight lifting plate 12 is disk shaped having a center hole sized to fit over sleeves 16 of barbell 10. Barbell 10 and plates 12 are preferably made of a metal such as steel or cast iron.

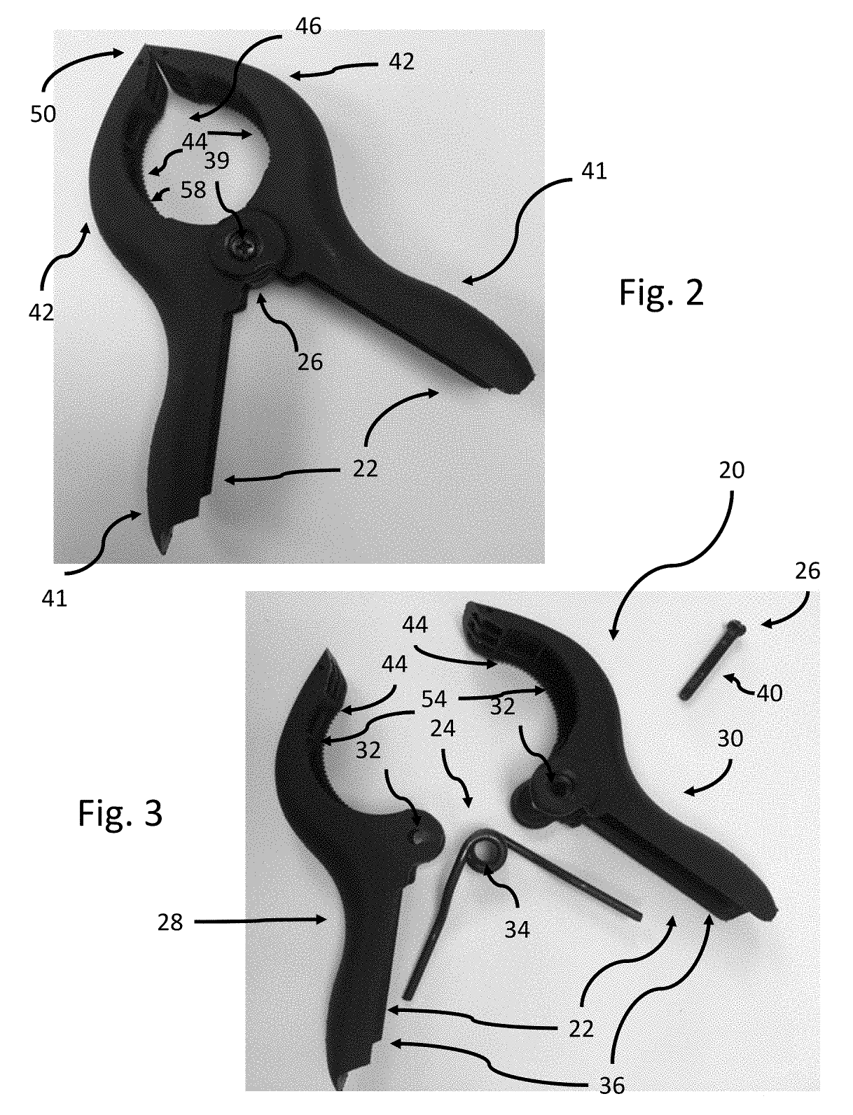

As shown in FIGS. 2 and 3, clamp 20 includes a pair of levers 22, a biasing spring 24, and a fastener 26. In one embodiment, plurality of levers 22 comprise glass reinforced resin. In other embodiments, plurality of levers 22 may comprise other plastics or metals. Levers 22 include first and second levers 28, 30 that cooperate with one another to form a through hole 32. When clamp 20 is assembled, a center hole 34 of biasing spring 24 aligns with through hole 32 and biasing spring 24 rests within cavities 36 formed by levers 22 and abuts inner walls 38 of levers 22. Fastener 26 passes between through hole 32 of levers 22 and center hole 34 of spring 24 to form a central axis 39 for clamp 20. In other embodiments, barbell clamp 20 may comprise fewer or more components or subcomponents.

Fastener 26 fastens biasing spring 24 between levers 22. In one embodiment, fastener 26 comprises a bolt 40, a locknut (not shown), and a washer (not shown). Bolt 40 is positioned in through hole 32 and passes through the width of levers 22. The locknut and washer attach to bolt 40 to secure levers 22 together. In other embodiments, other fasteners may include pins, rivets, nuts and bolts, or the like are provided to secure biasing spring 24 and levers 22 together. Referring to an exploded view of clamp 20 in FIG. 3, biasing spring 24 is attached between first lever 28 and second lever 30. In one embodiment, center hole 34 of biasing spring 24 and through hole 32 of levers 22 are positioned along the same axis. Biasing spring 24 is designed to continuously bias clamp 20 to a closed position, shown in FIG. 2. Bolt 40 passes through center hole 32 when securing biasing spring 24 within clamp 20.

First lever 28 and second lever 30 each have grips or handles 41 where a user applies force to open jaws 42 of each lever 28, 30. Jaws 42 each have contacting surfaces 44 that define an oblong hole 46 when closed. When opened, a gap 48 (see FIG. 1) between tips 50 of jaws 42 is larger than the two inch diameter of sleeves 16 of barbell 10 so that clamp 20 can be positioned over sleeve 16 from the side rather than inserting sleeves 16 into oblong hole 46. However, if desired sleeves 16 may be inserted into clamps 20. Simultaneously or after being positioned over sleeve 16, clamp 20 is positioned against plate 12 to secure plate 12 on sleeve 16.

When levers 22 are in a substantially closed position as shown in FIG. 1, contacting surfaces 44 form oblong hole 46. The overall shape of oblong hole 46 is ovoid—defined by contacting surfaces 44 and tips 50 of levers 22. A main region 54 of each contacting surface 44 is circular to match the circumference of sleeve 16. When substantially closed as shown in FIG. 1, the portion of hole 46 defined by circular main regions 54 match the circular circumference of sleeve 16 barbell 10. While in the substantially closed position on barbell 10, clamp 20 attaches to barbell 10 to resist plate 12 from sliding off of sleeve 16. In some embodiments, when clamp 20 is attached to barbell 10, tips 50 are not contacting each other so that gap 48 remains open. According to the preferred embodiment, when clamp 20 is removed from sleeve 16 and grips 41 are released, tips 50 contact each other so gap 48 is no longer present.

Referring to FIG. 5, in other embodiments, an insert 56, such as a rubber cover, may be attached to clamp 20 to further prevent clamp 20 from sliding along the length of sleeve 16 of barbell 10. Furthermore, insert 56 helps maintain the integrity of a coating on barbell 10, like zinc or chrome. In one embodiment, contacting surfaces 44 are covered by insert 50 so as to separate teeth 27 from directly contacting barbell 10 when clamp 20 is in a closed position around barbell 10. In some embodiments, insert 50 may comprise rubber or other known substitutes for rubber, such as silicone and neoprene. Moreover, insert 50 may be removable and interchangeable as it wears.

Contacting surface 44 engage sleeves 16 of barbell 10 and resist lateral movement of plates 12 along sleeves 16 of barbell 10 through friction and/or interlocking with sleeve 16. In one embodiment, clamp 20 is secured to barbell 10 by contacting surfaces 44, wherein contacting surfaces 44 includes teeth 58 that resist clamp 20 from sliding along sleeves 16 of barbell 10. In other embodiments, contacting surfaces 44 may also include rough surfaces or bumps to provide more friction and/or interlocking; such rough surfaces may include an abrasive surface or similar surfaces.

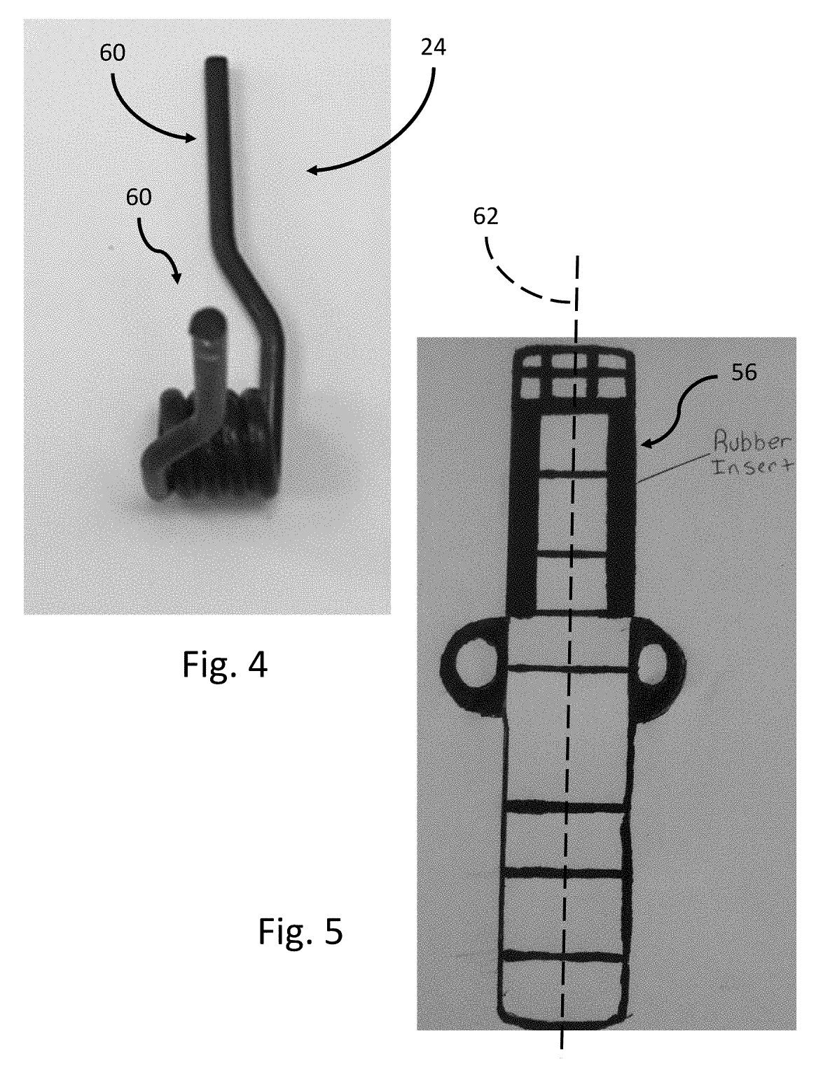

Referring to FIG. 4, in one embodiment, legs 60 of biasing spring 24 may have curvature configured to approximately align with a central longitudinal axis 62 of levers 22 and abut the inner walls 38 of levers 22. Such alignment may evenly distribute an applied force throughout jaws 42. Moreover, when in a closed position, biasing spring 24 provides spring force sufficient to create friction that prevents clamp 20 from sliding along sleeves 16 of barbell 10. Spring 24 is preferably made of plastic or a metal such as steel. In other embodiments, biasing spring 24 may comprise a spring or piston assembly situated between shafts 24. [0020] While this disclosure has been described as having an exemplar design, the present disclosure may be further modified within the spirit and scope of this disclosure. This application is therefore intended to cover any variations, uses, or adaptations of the disclosure using its general principles. Further, this application is intended to cover such departures from the present disclosure as come within known or customary practices in the art to which this disclosure pertains.

What is claimed is:

1. A barbell and barbell clamp assembly including:
a barbell having a shaft and two sleeves coupled to the shaft and
a barbell clamp including
a pair of levers pivotally coupled together, each lever including:
a jaw having a contact surface, the contact surfaces cooperating to define a central hole, the barbell being positioned in the central hole, and
a handle coupled to the jaw, the pair of levers being movable relative
to each other to move the contact surfaces towards and away from each other.

2. The barbell and barbell clamp assembly of claim 1, wherein the central hole is an ovoid shape.

3. The barbell and barbell clamp assembly of claim 1, wherein each contact surface includes serrated teeth.

4. The barbell and barbell clamp assembly of claim 1, wherein the central hole has a first major axis diameter at least as large as a diameter of each sleeve.

5. The barbell and barbell clamp assembly of claim 1, wherein the jaws include a jaw tips and the jaw tips contact each other when the barbell clamp is in a closed position.

6. The barbell and barbell clamp assembly of claim 5, wherein the jaw tips are configured to be separable by at least a diameter of each sleeve when the barbell clamp is in an opened position.

7. The barbell and barbell clamp assembly of claim 6, wherein the diameter of each sleeve is at least two inches.

8. The barbell and barbell clamp assembly of claim 1, wherein the barbell clamp further includes a means for biasing the barbell clamp towards a closed position.

9. A barbell and barbell clamp assembly including:
a barbell having a shaft and two sleeves coupled to the shaft, and
a barbell clamp including
a pair of levers coupled to the barbell, each lever including:
a jaw having a contact surface, the contact surfaces cooperating to
define a central hole, the barbell being positioned in the central hole; and
a handle coupled to the jaw; and
means for biasing the jaws towards a closed position, the biasing means being spaced apart from the central hole.

10. The barbell clamp assembly of claim 9, wherein the biasing means is a spring.

11. The barbell clamp assembly of claim 10, wherein the spring includes a coil and at least two legs that are aligned with the handles of the levers.

12. The barbell clamp assembly of claim 10, further comprising a means for fastening the pair of levers together.

13. The barbell clamp assembly of claim 12, wherein the means for fastening passes through a through hole in each lever and a hole in the spring.

14. A barbell and barbell clamp assembly including:
a barbell having a shaft and two sleeves, and
a barbell clamp including
a pair of levers, each lever including:
a jaw having a rubber contact surface, the rubber contact surfaces cooperating to define a central hole, the barbell being positioned in the central hole; and
a handle coupled to the jaw.

15. The barbell clamp assembly of claim 14, wherein each rubber contact surface is removable.

16. The barbell clamp assembly of claim 14, wherein each jaw has a serrated edge.

17. The barbell clamp assembly of claim 16, wherein each rubber contact surface overlays each serrated edge.
